(19) United States
(12) Patent Application Publication
(10) Pub. No.: US 2014/0038720 A1
(43) Pub. Date: Feb. 6, 2014

(54) Game Board

(71) Applicants: Wouter Reeskamp, Amsterdam (NL); Tijn Martinus Maria Kooijmans, Amsterdam (NL)

(72) Inventors: Wouter Reeskamp, Amsterdam (NL); Tijn Martinus Maria Kooijmans, Amsterdam (NL)

(73) Assignees: STUDIO SOPHISTI V.O.F., Amsterdam (NL); IDENTITY MANSION B.V., Rotterdam (NL)

(21) Appl. No.: 13/982,387

(22) PCT Filed: Jan. 31, 2012
(86) PCT No.: PCT/NL2012/050054

§ 371 Date: Oct. 15, 2013

Related U.S. Application Data
(60) Provisional application No. 61/437,938, filed on Jan. 31, 2011.
(60) Provisional application No. 61/454,154, filed on Mar. 18, 2011.
(60) Provisional application No. 61/466,571, filed on Mar. 23, 2011.

(30) Foreign Application Priority Data
Mar. 18, 2011 (NL) 2006428
Mar. 21, 2011 (NL) 2006109
Mar. 23, 2011 (NL) 2006459

(51) Int. Cl. A63F 13/02

(52) U.S. Cl. CPC A63F 13/02
USPC 463/40

(57) ABSTRACT

Described is a game board for playing a game supported by a tablet computer having a display, wherein the game board includes a playing field and accommodation means for accommodating the computer, wherein the playing field comprises one or more sensing elements, which upon activation, send a signal to the tablet computer. Furthermore, a method for operating the board by one or more game participants is described.

### FIELD OF THE INVENTION

The invention relates to a game board for playing a computer game, controlled by a tablet computer having a display, comprising a playing field and accommodating means for accommodating a tablet computer.

### BACKGROUND OF THE INVENTION

For several decades computers having a display have been used to play games. Various control means are used to control them, such as a keyboard, a joystick and/or a gamepad. There are also portable game consoles on the market (produced by companies such as Nintendo and Sony) in which a small display, and control buttons, are included in an enclosure. Such portable game consoles on the market may also feature a touch screen. The game is controlled by touch alone and/or together with game buttons.

Recently so called tablet PCs have appeared on the market, such as the Modbook produced by Axiotron, the iPad by Apple, and the Galaxy Tab by Samsung, which are controlled by using touch screen technology, and do not have a keyboard. On these tablet PC's, games can be played. Similar technology is comprised by palmtops (also known as personal digital assistant, PDA), smartphones (such as the iPhone of Apple and the Galaxy series of Samsung) and portable audio- and video players (such as the iPod touch of Apple), which have similar or same functionalities, however have a substantially a smaller format. These devices often use a touch screen for control, optionally in combination with a small keyboard. Again, games can be played on these devices. Herein, the term tablet computer is therefore not to be limited to only the above described tablet PCs, but also to their smaller sized counterparts. At present, tablet PC's have dimensions in the range of 20-30×10-20×0.5-2 cm, although the dimensions of the above-mentioned Modbook are slightly larger. The term ‘tablet computer’ as used herein is therefore intended to encompass the above tablet pc's as well as the smaller sized palmtops, smart phones and portable audio- and video players.

One of the drawbacks of playing games on a computer is the lack of a playing field, where a game participant can perform game actions. The game actions in computer games are controlled by a computer, by touching the computer screen, or by operation of the buttons. This is not easily achieved, in particular when a game is played by several people simultaneously, since the computer does not offer enough room for multiple players to follow the game on the display, and to properly control the game. Most of the time, when multiple players participate in a game, this is achieved by connecting multiple computers with one another, each individual player participating to the game with his own computer. The players are therefore not necessarily together but in separate rooms, without physical or eye contact. The personal interaction between players is therefore lacking. This is seen by many as a major drawback. Moreover, computer control by the computer requires manual skills, and therefore requires practice, making games for a large group of players unattractive.

Computer games are therefore not particularly suitable to be played by parties of more than one person. Known party games, such as board games, are much better suited. In these games the players gather around a common game board, on which the game takes place. Examples of such games are Monopoly, Settlers of Catan, Backgammon, Cluedo, etc. Even games like Dominoes, Memory and Rummikub, which use individual pieces played around an initially empty field, are popular party games. However, it has been noticed that children often prefer to play games on a computer, therewith not arriving at a party effect.

US2007/0197273. describes a game board with a playing field, wherein a portable game console can be received. The playing field and the game board however are not functionally linked. Accordingly, pawns can be moved on the same field, and subsequently a button on the control console can be operated manually to view an animation belonging to the game, or to give a command determined by the course of the game play on the playing field.

One of the drawbacks of the game board of the prior art is the fact that movements on the playing field do not affect the game console. The game console must be manually operated to end each turn. In addition the prior art does not provide a solution for the needs of players to play a game with more than two persons as a board game. The display of the portable game console is too small to be looked on by multiple players simultaneously. The game board according to the prior art is unsuitable, and therefore intends to provide a variant extension of existing computer games for one, or at most two persons.

In the art, several game devices are described, where a personal computer is functionally linked to a game board. However, these computers are not accommodated on the game board. Such devices are not portable, and because of the different architecture, the display of a personal computer is not accommodated on the game board, therewith limiting the versatility of such devices. In this respect, reference is made to WO97/17117, WO96/03188 and GB 2198046A.

### PURPOSE AND SUMMARY OF INVENTION

This invention aims to solve at least one of the above problems and provides thereto a game board according to Claim 1. With such a game board, it is no longer necessary to each time manually control a game computer received in the game board.

The playing field thereto comprises one or more sensing elements, that are capable of detecting the presence or absence of a game piece on one or more predefined positions on the game field. When a game piece, such as a token, a pawn, or e.g. a finger of a player, is positioned at or at the proximity of such a predetermined location of the game board, the sensing element can generate a signal, and sends the signal to the tablet computer or vice versa. It is also possible that the sensing elements are designed such, that a signal is generated when a game piece is removed from a predetermined position on the game field. Such a signal can be generated instead, or in addition to the signal, generated when a game piece is positioned at the respective predetermined position of the game fields. With ‘game piece’ is meant any article used to play the respective game on the game board, which can be e.g. a token, or a pawn. In another embodiment, the game piece can also be a finger of a player. The term ‘sensing element’ therefore equals the more functional term ‘game piece sensing element’, both used herein.

The predetermined positions can be designed as discrete areas on the game board. With ‘discrete’ is meant that a player can discriminate between the discrete areas. This can e.g. be achieved by using different colors for different areas. So when the game board comprises more than one of such predefined positions, the discrete areas enable the player to discriminate between the said areas (and therewith between the different predetermined positions) so that the player can choose which area to touch, or to which area a pawn or token has to be moved or placed.

The sensing elements are preferably chosen from the group, consisting of pressure sensitive, capacitive, optical, inductive, magnetic, electrical and electromagnetic sensors. Such sensor can detect the presence or absence of a game piece on a predefined position the game board. When a game piece, such as a pawn, is positioned on the respective predetermined position on the game board, the sensor detects the game piece and sends a signal to the tablet computer. Such a signal can also be generated when a game piece is removed from the said position, or when the said position is touched, e.g. by the finger of a player.

In accordance with the above, the playing field of the game board can comprise a touch screen, or e.g. arrays of sensors.

In a preferred embodiment, a sensing element is designed as a pressure sensitive element, which upon receiving or reducing pressure, sends a signal to the tablet computer. Such a signal can be achieved, for example, by exerting a pressure, e.g. by placing a pawn, or by manual pressure, such as by pressing a finger on the playing field, or by sliding, upon exerting some pressure, one or more fingers across the playing field. One can also exert or reduce pressure on the game board by moving a game figure, such as a pawn, on the game board. The pressure at the position left by the game figure reduces, and the weight of the game figure exerts pressure at the new location on the game field. Such pressure sensitive elements are known in the art, and may be e.g. placed in, or on the game board. The playing field can be provided with a plurality of pressure sensitive elements, as a result of which the playing field comprises discrete pressure sensitive areas. It can be chosen to place elements having different pressure sensitivity in or on the game field, so that more pressure is needed to generate an equally strong signal, with respect to another location, where a more pressure sensitive element is placed. The pressure sensitive elements can have on/off characteristics intended to mean that a signal, regardless of the degree of pressure received, is sent to the tablet computer, once a certain pressure threshold is exceeded. However, it can be chosen to place elements, of which the strength of the signal to be sent, depends on the pressure that is exerted on the respective pressure sensitive element. It is also possible to place a continuous pressure element on or in the playing field, which element can send information on the degree of pressure and/or location where pressure is exerted on the element (or is removed thereof) to a tablet computer. The playing field can also comprise a touch screen, which is in this respect to be regarded as a pressure sensitive element generating a signal corresponding to the location on the screen where the screen was touched or pressed on. Cost considerations currently prefer the positioning of separate elements on/in the playing field. However, as indicated above, many alternatives, known to the skilled person, are known as suitable sensing elements for the game board of the invention.

In addition to the statements above, a ‘tablet computer’ is herein defined as a portable computer, i.e. less than 4 kg in weight, preferably less than 2 kg, having the form of a tablet, preferably being of a rectangular shape, the upper surface thereof comprising a display, preferably a touch screen. Preferably, a tablet computer is a single unit having a single shape configuration, meaning that the shape is not significantly changed during the use thereof by elements hinging or sliding with respect to one another in order to be able to be used. The tablet computer should be capable to support the necessary game software for controlling the computer game. Smart phones, palmtops and portable audio-and video players that comply with the above are therefore encompassed by the term ‘tablet computers’. Examples of the above are presently the iPad, the iPhone and iPod touch of Apple, the Galaxy smartphone and Galaxy Tab of Samsung. Preferably, the tablet computer is therefore chosen from the group, consisting of a tablet PC, a personal digital assistant (PDA), a smartphone and a portable music- and video player. Most preferred are the products of Apple as described above. It is to be understood that not all e.g. portable music- and audio players are suitable as tablet computer for the game board of the present invention. An important prerequisite is that the tablet computer is capable of running the game software necessary to control the computer game to be played on the game board. The preferred maximum dimensions of a tablet computer for use in the present invention are 30×20×2 cm, more preferably 25×20×1 cm. The minimal dimensions are preferably 100×55×7 mm.

The game board invention enables to play a game, with the gaming sensation and experience as of a common board game, wherein the tablet computer, by receiving signals transmitted by the pressure sensitive elements, produces various audiovisual effects, not possible in a normal board game. For example, the display of the tablet computer may show the game effects when a player arrives, with his game figure, at a certain location on the game board, resulting in a certain game action to occur. The display, preferably supported by a speaker, also controlled by the tablet computer, may for example announce the respective game action, e.g. by an animation, or can provide the player with instructions. One can use a touch screen to define players; the tablet computer can keep track of the players' turns, and can control tokens or play money for each player, so that corresponding game attributes become redundant. The display of the tablet computer can also be part of the playing field, and can provide a computer controlled variability in the playing field. With this invention the possibilities of classic board games, such as Monopoly or any other board game, are almost infinitely expanded and a dynamic addition to the board game is provided. The invention makes playing board games for children who tend to prefer game consoles, attractive again. Further, the games to be played with the game board are not limited to those that are suitable to be played by more that one person, like the games described above. Also games that can be played alone, such as card games like solitaire, or Tarot can be played with the game board of the invention in an attractive manner.

With the term ‘game’, not only the above party games, board games, games suitable to be played alone, and computer games are intended to be encompassed, but also educational games. Educational games are intended to encompass computer supported teaching material in any educational field, such as doing sums, writing, foreign languages, geography, and history etcetera. For example, the display of the tablet computer can display a sum to be solved, and a plurality of proposals for the solution of the sum. Each proposal can be assigned to a particular identifier, such as a color, number or character. So the sum may have several, e.g. four, proposed solutions, the first solution being marked with e.g. ‘a’, or ‘1’ or by the color blue. Accordingly, the second solution can be marked by ‘b’, ‘2’, or yellow, etcetera. The playing field then comprises a plurality of areas that each correspond to a proposed solution, each area thereto being marked with the identifier, corresponding to the said solution. This embodiment enables educational ‘question and answer’ games to be played, and provides enormous potential as educational means to be used at schools etcetera. Foreign languages can be learned by displaying a foreign word or phrase with a number of proposed meanings on the display of the game board. Or a geographical map can be displayed, and a question can be to identify a location on the map. It is also possible to display an animation of e.g. a historical event, and the question is to identify the event among a number of proposed answers. If the playing filed comprises a touch screen, the game participant can also write the proper answer, so that also open questions can be displayed, without the need to propose a number of possible answers. Such an embodiment would also enable to learn writing.

The game board of the invention comprises accommodating means for accommodating the tablet computer on the game board. By these means, the tablet computer can be incorporated in the game board, resulting in the game board and the tablet computer being capable of being regarded as a single unit. This embodiment also enables the display of the tablet computer to be integrated in the playing field of the game board. This embodiment is particularly advantageous when a finger of a player is used as game piece, but is also advantageous in cases when the game piece is designed as a token or pawn.

Regarding the above, the accommodating means allow accommodation of the tablet computer such, that when the tablet computer is accommodated on the game board, the display of the tablet computer is substantially parallel to the plane of the playing field. This way, the display of the tablet computer is optimally integrated in the game board and may become an integrated part of the playing field. Thereto, the distance between the display of the tablet computer and the playing field is preferably less than twice the thickness of the tablet computer. The game board can comprise a recess, capable of accommodating the envisaged tablet computer, to even allow the display of the tablet computer to be in the same plane of the playing field.

The playing field of the game board of the invention preferably extends from at least one side of the tablet computer, when accommodated on the game board. This means that the tablet computer, when placed in the game board, is adjacent to the playing field. This is attractive because, by the action on the playing field, onscreen image information can be generated by the tablet computer, which information can be intended for any of the players concerned. This arrangement makes the board accessible to a plurality of players.

Preferably the playing field extends in at least two opposite directions from the tablet computer, when accommodated on the game board. By this arrangement the tablet computer is between at least two portions of the playing field. By this central position, the accessibility of the screen is well for the players, whereas the playing field is also easily accessible. This arrangement is also ideal when games are played with two players or two teams of players playing against each other, with each opponent or each team getting the availability of their own hold of the playing field. The playing field may also extend around the receiving means so that the tablet computer, when placed in the game board, is located in the middle of the game board. The playing field may therefore extend from all sides from the tablet computer, i.e. in four directions, each direction being 90° to the neighboring extension. The contours of the game board may have any form, such as rectangular, square, oval, round, or irregular. The other players around the game board all maintain an optimum access to the others players can position themselves around the game board and all maintain an optimum access to the game board.

In an attractive embodiment, the playing field is hinged. This enables compact construction by which the game board is easy to be put away. Preferably, the board is hinged around the tablet computer when it is placed this providing additional protection to the tablet computer. By this design it is also not necessary for the tablet computer to be removed from the game board.

The game board according to the invention preferably comprises connecting means for establishing an operational link between the board and the tablet computer, when the tablet computer is received on the game board, to transmit a signal from one or more pressure sensitive elements to the tablet computer. By these connecting means e.g. a wireless connection can be established and maintained by e.g. using Bluetooth technology, or any other wireless technology, that can be received by the tablet computer used. The game board can also be provided with a receiver for signals that can be wirelessly transmitted by the sensing elements, whereby the receiver is coupled to the tablet computer, so that the tablet computer receives the wireless signals in a computer readable and processable form. However, the sensing elements are preferably connected with the tablet computer via a wired connection since it is less susceptible to interference and requires less costly techniques. The connection means may thereto comprise a plug that specifically fits on the tablet computer, which is connected to the wiring of the sensing elements, or may have other types of receiving means for receiving the signals sent from the sensing elements. An example of such connection means is the 30-pin connector known for the above described apple products. The signal can thus be sent to the tablet computer in many ways known in the art, like wireless. As a wired connection is preferred, the signal of the sensing signals comprises preferably an electronic signal.

The game board preferably includes a converting module, or an interface suitable for converting the signals form the sensing elements, to signal that the tablet computer can process and convert into an audiovisual signal. Such a converting module will be of different architecture, depending on the tablet computer used. It is important that the signals sent from the sensing elements are converted by using the interface into a computer processable and readable form, if necessary.

The receiving means for receiving a tablet computer in the game board can have any desired shape, as long as the tablet computer remains fixed on the game board. A tablet computer, for example may snap onto the board or slide into a frame, which is attached to the game board, or be placed in a recess of the game board, which recess is specifically provided for this purpose. Also the game board may have raised edges, which define space on the board that matches the size of the tablet computer to be placed. It is also possible that the connecting means, such as the 30-pin connector as described above function a receiving means or part thereof to fix the tablet computer on the game board.

The receiving means for receiving the tablet computer are preferably such that it allows repeatedly placing the tablet computer in the board and removing the tablet computer from the board. For example, the tablet computer can be engaged to the game board by snappy edges. By pulling apart the snappy edges, the tablet computer can then simply be removed from the board.

The receiving means for receiving the tablet computer in the board may attractively include a frame in which the tablet computer is held. Herewith a solid and reliable holding device for the precious tablet computer is provided, allowing an easy insertion and removal of the tablet computer.

The board of the invention needs energy e.g. to generate the signals and to send these to the tablet computer or for example to illuminate the playing field. Accordingly the board can comprise its own energy, such as a battery. The energy of the game board of the invention is however preferably provided by the tablet computer to be received therein. To that end the connecting means, which have already been discussed above can be designed accordingly. By this, a separate battery for the game board is not required.

In a very attractive embodiment, the field comprises a replaceable playing surface. In or on the board, sensing elements are mounted. Thereon, a playing surface is applied that defines the appearance of the playing field. By designing this game surface, interchangeable multiple, different games can be played on the game board. These surfaces can for example be printed by the player himself and be placed on the playing field, or be offered separately or together with game software, e.g. on a data carrier, in the form of a kit. Attractively, when buying a game via a web shop, for example, the software for the game, as well as printing instructions for the corresponding playing surface can be downloaded. On the other hand, playing surfaces can be offered separately, enabling the said sheets to be of high quality. The said sheets can be designed as printed skins, which can be placed on the playing field.

The image of the playing surface will be designed such that it defines areas that correspond to locations on the playing field where one or more sensing elements are located. The areas are, when the playing surface is placed on the playing field, aligned with one or more pressure sensitive elements of the playing field. These areas can be discrete areas, such as a particular box, for example when the playing surface is designed to represent the playing surface of the board game Monopoly. Each street on such a monopoly board is then a distinct box, i.e. a discrete area. On the other hand, the area can be part of a larger image, such as e.g. a geographical map. The area or areas in this embodiment correspond with particular geographically interesting locations, such as cities, states, mountain ranges, rivers etc. Such playing surfaces can be used e.g. in educational games, where a question is displayed on the display of the tablet computer asking to point at a particular city, mountain range etc.

The sheets preferably comprise mounting means for mounting the playing surface on the playing field of the fame board. Such mounting means can e.g. comprise Velcro, that cooperate with Velcro present on the game board. The sheet can also be designed as a skin such as a fitted sheet, comprising elastic edges that can be folded around the edges of the playing filed or game board. The skilled person will be readily aware of possible mounting means in order to mount and fix the playing surface on playing field.

In another attractive embodiment, the game board of the invention comprises moving parts, whose motion can be controlled by the tablet computer received in the board. Thus the game board can, for example be designed as an obstacle course, for example by providing one or more locations on the board, where a playing figure can be located. Surfaces under a spring tension, which spring can relax by computer control, results in shooting away the said surface. By this, the playing figures can be shot away from the board. The board may for example, also contain elements such as small projectiles, which can be fired, under the control of the tablet computer. This creates an extra dimension of tension and surprise in the game.

In another attractive embodiment, the game board of the invention comprises connecting means for one or more additional computers having a display, by which connecting means signals between the tablet computer accommodated on the playing field and one or more additional computers can be transferred. The playing field may thus include multiple displays, increasing the number of possibilities for playing games enormously. Thus, the display of an additional computer can be intended for a specific player or team, and not for another player or another team. Also, the tablet computer accommodated on the playing field can have the function of a common display showing play information for all players, while on one or more displays information is displayed that is specific to one player above, and perhaps for another player to keep confidential. These additional computers are preferably small in size, and are preferably placed around the game board. The respective connecting means are therefore preferably arranged at the edge of the board. The additional computers are preferably also tablet computers as defined herein, and preferably selected from the group consisting of a palm top, a portable game console, a smartphone or a portable audio- and video player. In an attractive embodiment, the additional computers are selected from the group iPhone, iPad, and iPod, even more preferably iPhone and iPod.

As has already been stated above, the display of the tablet computer or the one or more additional computers preferably comprises a touch screen. This enormously increases the possibilities for playing games. Thus the display can also be part of the playing field, since the display itself is also touch sensitive and thus responds to pressure differences that are caused by the players.

The invention relates to a method for controlling a game on a game board according to any one of the preceding claims, comprising:

a) establishing an operational link between one or more of the sensing elements of the game board and the tablet computer;

b) detecting the operational link of step a);

c) displaying a first image on the display upon detecting of step b);

d) receiving of at least one signal from at least one of the sensing elements by the tablet computer;

e) processing of the signal of step d) according to predetermined rules;

f) generating image data for a second image based on the processed signal of step e);

g) displaying the second image of step f) on the computer display;

h) repeating steps d)-g).

By placing the tablet computer in the receiving means of the game board, an operational link between the tablet computer and the game board is set up. Once the connection is established, and the software required for the intended game is loaded, in step c) an initial image is activated. This initial image may include various information and menus, from which players can choose. For example, the rules can be displayed, a choice between several game modes can be made, the number of players can be set, and game figures are assigned to players. These choices can for example, be made by touching the display, i.e. the touch screen, or certain spots on the playing field. When the game starts, the tablet computer can generate and display instructions that guide the player through his turn. Likewise, it can be started with virtually throwing a dice, where after the player moves his game figure on the playing field accordingly, by which local pressure differences are generated on the playing field, which pressure differences are converted by the sensing elements into a signal that is sent to the tablet computer. The tablet computer receives the signal and processes the signal according to predetermined rules, which may be dictated by the game software running in the tablet computer. The software can for example not allow incorrect positioning of the game figure for example on a wrong place on the playing field. It is possible for example that the game can only proceed if the game figure is placed in the correct position on the playing field. The tablet computer can therefore control the right course of play and prevent cheating. Also by arriving at a specific place on the playing field, the tablet computer may start a game animation, may generate a question for the player, may give the player an assignment, or may change the display as a whole, or in part into an additional portion of the game field surface. When the turn is over, the tablet computer can announce this by means of a following display and the turn goes to the next player. This cycle, i.e. steps d)-g) can be repeated throughout the game. Once a player has achieved the goal of the game e.g. by taking a determined location on the playing field, the tablet computer can generate a last image or an animation on the display that e.g. instantly names the winner and/or points scored. The game can e.g. be played with game figures such as pawns, by which the sensing elements are activated so that these send a signal to the tablet computer. The signal can also be generated by exerting pressure manually by a sensing element of the game board. This can be done by pressing locally on the playing field, or if desired, by sweeping over the playing field.

The invention also relates to a method for operating the game board according to the invention by one or more game participants, comprising the steps:

1) placing the tablet computer in the accommodating means of the board,

2) connecting the tablet computer to the connecting means to establish an operational link between the sensing elements of the playing field and the tablet computer,

3) activating the appropriate game software in the tablet computer, making it generate an initial screen image, which is perceptible to the one or more game participants,

4) touching on one or more sensing elements in the playing field by a game piece of one or more game participants, generating a signal, which is transmitted to the tablet computer,

5) generating a next image by the tablet computer,

6) repeating steps 4) and 5).

Furthermore, the invention relates to a computer program product comprising instructions that are readable and executable by a tablet computer and are suitable to be received in a game board according to the invention, enabling the tablet computer to perform the method of the invention. This computer program product can be offered to consumers via the internet, where from the program product can be downloaded. The computer program can also be recorded on a suitable carrier, such as a CDROM, DVD, memory card, or memory stick. The invention therefore also relates to a data carrier on which the computer program product of the invention is stored.

The invention further relates to an assembly of a board of the invention having received therein a tablet computer, having a display, preferably a touch screen, such as an iPad, iPhone or iPod touch.

In another embodiment, the invention relates to a playing surface for placing on a playing field of the game board according to the invention, comprising a sheet on which areas are defined, which areas correspond with the location of one or more pressure sensitive elements of the game board, when the playing surface is placed on the playing field of the game board. The said playing surface preferably comprises mounting means for mounting the playing surface on the playing surface of the game board.

Another embodiment of the invention encompasses a kit, comprising a playing surface as described above, and a computer program product as described above, optionally on a data carrier, e.g. as described above.

### BRIEF DESCRIPTION OF FIGURES

The invention will now be explained with reference to the following figures, wherein:

FIG. 1 shows a top view of a game board according to the invention,

FIG. 2A shows a cross section through arrow A in FIG. 1,

FIG. 2B shows a cross section of a similar game board in a closed position.

FIG. 3 shows a top view of a game board according to the invention wherein a tablet computer is received,

FIG. 4 shows a top view of a game board with an alternative playing field,

FIGS. 5A and 5B show different playing surfaces.

FIGS. 6A and 6B show an embodiment of the game board in top view and in perspective, respectively, suitable for accommodation of a smart phone or portable audio- and video player.

### DESCRIPTION OF EMBODIMENTS

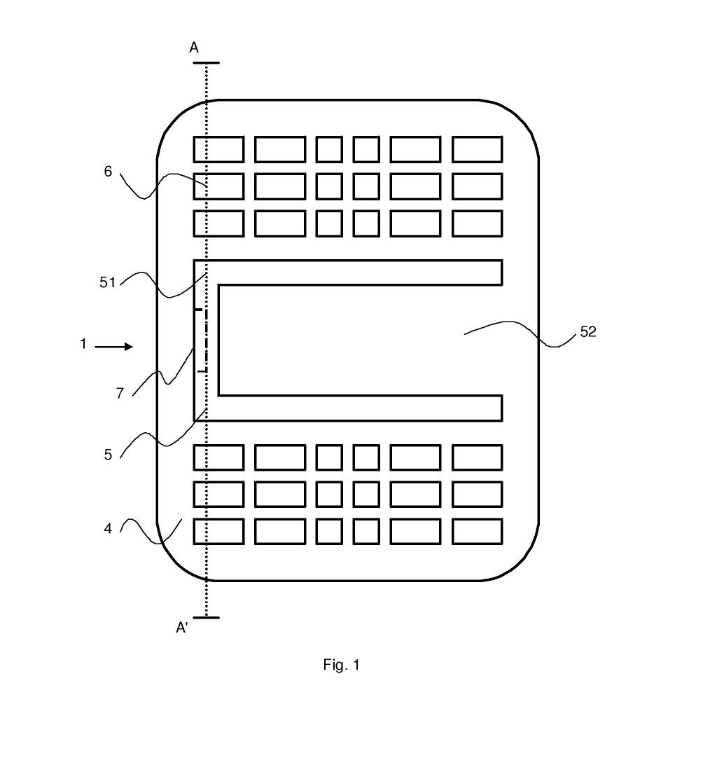

FIG. 1 shows a game board according to the invention. The game board 1 includes a playing field 4, comprising sensing elements 6, here designed as pressure sensitive elements. The field extends in both sides of accommodating means 5 for a tablet computer such as an iPad (not shown), therewith dividing, in the case shown, the playing field into two equal oppositely arranged portions. The receiving means are formed by a Uframe arranged on its side, wherein a tablet computer can be slide in through opening 52.

In the Uframe, a plug connector 7 is placed with which the tablet computer can be connected with the game board. The wiring between the sensing elements 6 and the connecting modules is not shown. Both playing halves preferably have a size equivalent to a standard paper size as a DIN A4 (approx. 21×30 cm) or the U.S. letter size (about 22×28 cm), to enable placing a playing surface of this size. By choosing the size of the playing surface such, the playing surface can easily be printed by a standard printer on a sheet of paper of standard size.

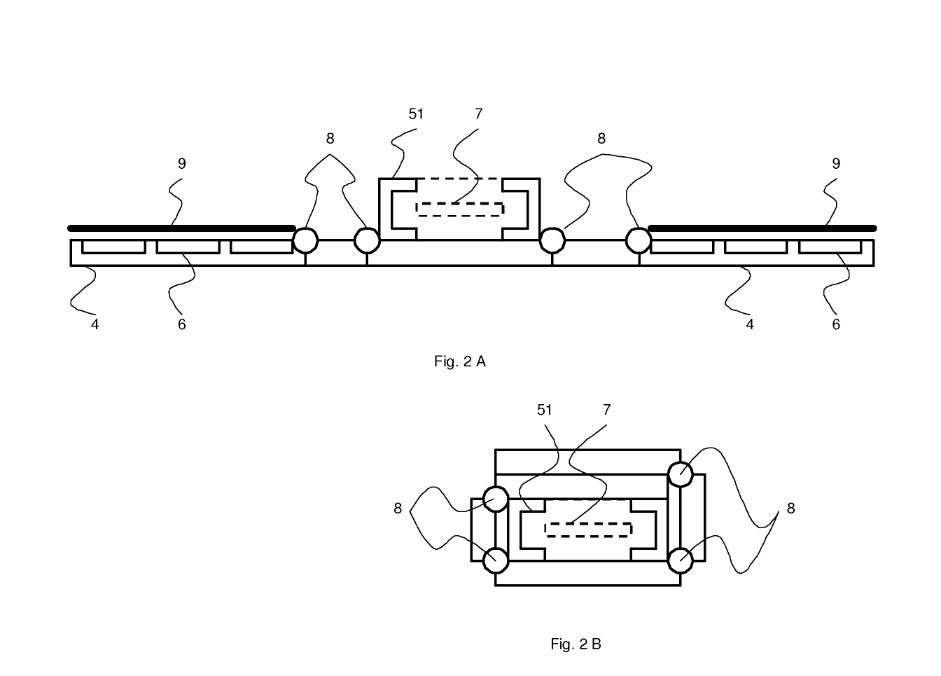

FIG. 2A shows that the sensing elements 6 are incorporated into the playing field 4. These elements can also be placed on the playing field. On the playing field, a sheet 9 is arranged as a playing surface, which sheet is printed so that the desired field is formed. Sheet 9 can be held in place on the playing field by using appropriate holding or mounting means or protective foil. In 51, the Uframe is shown wherein the tablet computer can be received. By 7, the location of the plug connector is shown, which is located below the plane of the drawing. On both sides of the Uframe, at 8, the playing field is hinged.

In FIG. 2B, the playing field is folded around the position where the tablet computer is to be received in the board.

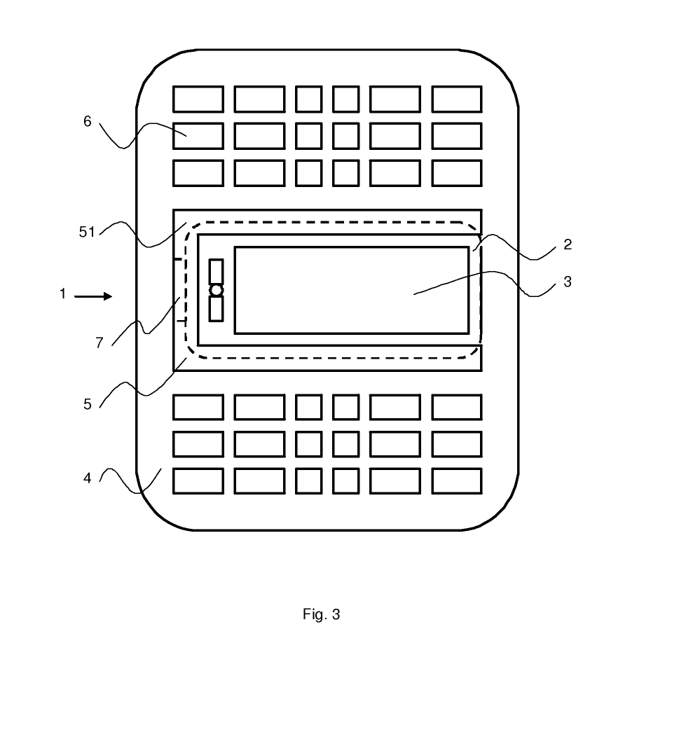

FIG. 3 shows the same game board as shown in FIG. 1, wherein a tablet computer 2 with touch screen 3 is received in the game board 1. Corresponding parts are not all shown. Tablet computer 2 is connected with the game board via the plug connector 7. The tablet computer 2 includes a control module such as a microprocessor, a DSP or a microcontroller and a memory for storing a computer program product, such as a computer program, also known as an “app”. This computer program includes instructions that enable the control module to control a game that can be played on the game board 1. The tablet computer 2 is operationally linked with sensing elements 6, here designed as pressure sensitive elements, via a connection module to receive signals generated by the sensing elements 6, with or without processing these signals before. The operational connection can be established by an electrically conductive connection or wireless, such as a Bluetooth or RFID connection. The operational connection is detected by the tablet computer 2, and especially by the processing unit thereof. Upon detection of this connection, an image is shown on the touch screen display 3, for example comprising game instructions. The tablet computer 2 receives signals from the sensing elements 6 via the operational link. In this way, the tablet computer 2 can for example determine where on the playing field pawns are placed and/or how they are moved. These signals are processed based on predetermined rules that are included in the computer program product. Based on the processed signals, and so based on the results of processing, a second screen or second image is generated, which e.g. shows the state of the game shows, for example by displaying a score. Alternatively, the second screen can display further instructions or hints. This second image is then displayed on the touch screen 3. The computer program product may be provided on a physical data carrier, but can also be obtained via a network connection by which the tablet computer 2 makes contact with a virtual shop where the product can be purchased.

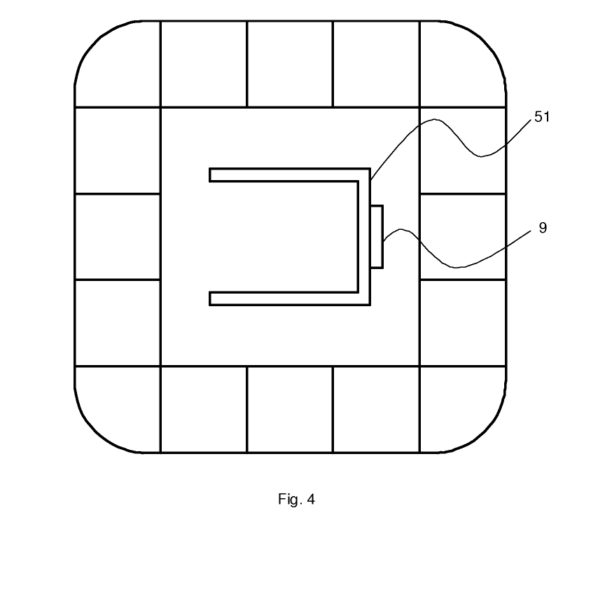

FIG. 4 shows a square game board where the game board extends around a Uframe. 9 shows an interface that converts the signals from the sensing elements (not shown, but can be positioned in the squares or corner sections) into signals that are readable and processable by the tablet computer. In the other figures, the interface is not shown, but it can for example, be placed under the game board, or in the Uframe, or on the playing field.

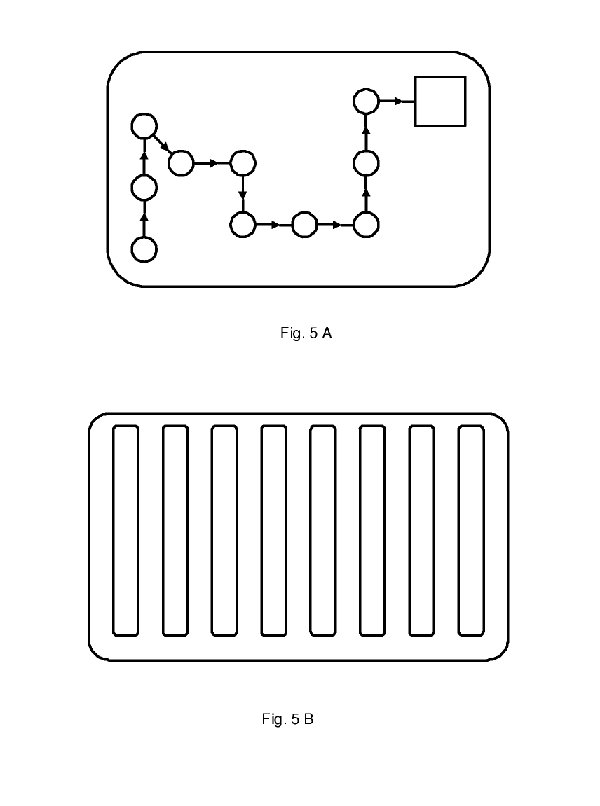

FIG. 5A shows a playing surface having predetermined locations indicated by open circles, intended for a game figure to be placed on. Aligned with these locations, a sensing element is located on the playing field, which sends a signal to the tablet computer as soon as a playing figure is moved to this location or away there from. By this signal, the tablet computer can generate information images on the screen display.

FIG. 5B shows a playing surface on which strips are shown as open rectangles, where players can sweep their fingers along to generate a signal or a set of signals for the tablet computer.

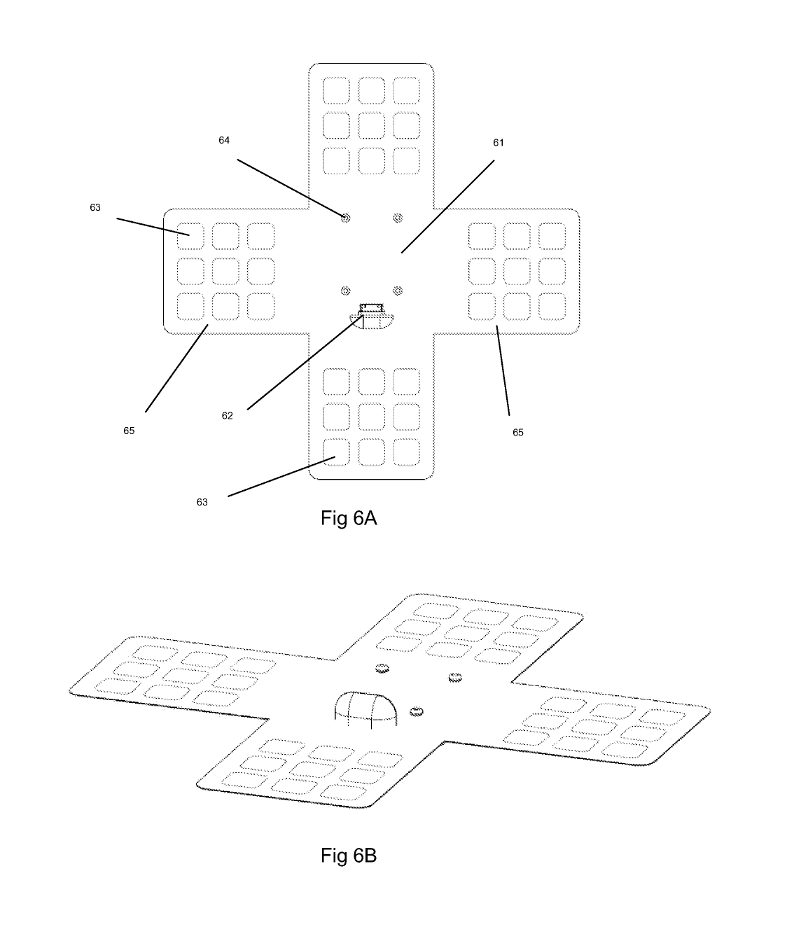

FIG. 6A shows a game board 61 according to the invention, suitable for accommodation of an iPhone or iPod. The game board comprises a 30-pin connector 62 for connection with an iPhone or iPod. Support elements 64, e.g. in the form of rubber washers, support the iPhone or iPad when accommodated on the game board, and prevent the iPhone or iPad from slipping from the game board. In this example, the accommodating means are constituted by the support elements 64 and the connector 62.

A playing field 65 extends in four directions, each direction being 90° to the neighboring extension. In each extension, the playing field comprises sensing elements 63. As in all examples, the sensing elements are operationally connected to the connector.

FIG. 6B is a perspective view of the game board 61 as shown in FIG. 6A.

1. Game board for playing a computer game, controlled by a tablet computer having a display, where the game board includes
a playing field, the playing field comprising a plurality of sensing elements, each capable of detecting the presence of a game piece on one or more predefined positions on the playing field, which sensing elements are capable of generating a signal upon said detection,
accommodating means for accommodating the tablet computer on the game board, and
connecting means to establish an operational link for signal transfer between the sensing elements of the playing field and the tablet computer.

2. Game board according to claim 1, wherein the one or more predetermined positions are discrete areas on the playing field.

3. Game board according to claim 1, wherein the sensing elements are chosen from the group, consisting of pressure sensitive, capacitive, optical, inductive, magnetic, electrical and electromagnetic sensors.

4. (canceled)

5. Game board according to claim 1, characterized in that the tablet computer is chosen from the group, consisting of a tablet PC, a personal digital assistant (PDA), a smartphone and a portable music- and video player.

6. Game board according claim 1, wherein the accommodating means allow accommodation of the tablet computer such, that when the tablet computer is accommodated on the game board, the display of the tablet computer is substantially parallel to the plane of the playing field.

7. Game board according to claim 1, wherein a distance between a display of the tablet computer and the playing field are less than twice a thickness of the tablet computer.

8. Game board according to claim 1, characterized in that the playing field extends from at least one side of the tablet computer, when accommodated on the game board.

9. Game board according to claim 8, characterized in that the playing field extends in at least two opposite directions from the tablet computer, when accommodated on the game board.

10. Game board according to claim 1, characterized in that the playing field is hinged.

11. Game board according to claim 1, characterized in that the accommodating means for accommodating the tablet computer on the game board permits repeated placing and removal of the tablet computer onto and from the game board.

12. (canceled)

13. Game board according to claim 1, characterized in that the signal of one or more sensing elements comprises an electronic signal.

14. (canceled)

15. (canceled)

16. Game board according to claim 1, characterized in that the playing field includes a removable playing surface.

17. (canceled)

18. Game board according to claim 1, characterized in that the game board comprises additional connecting means for one or more additional computers having a display, which connecting means are able to transfer signals between the tablet computer and the one or more additional computers and the one or more additional computers comprise a table computer, preferably a tablet PC, a smartphone or a portable audio- and video player.

19. (canceled)

20. Game board according to claim 1, characterized in that a display of the tablet computer or the one or more additional computers comprises a touch screen.

21. (canceled)

22. (canceled)

23. (canceled)

24. (canceled)

25. (canceled)

26. Computer program product, comprising instructions that are readable and executable by a tablet computer that is suitable to be accommodated in a game board according to claim 1, enabling the said tablet computer to perform a method including the steps of:
a) establishing an operational link between one or more of the sensing elements of the game board and the tablet computer;
b) detecting the operational link of step a);
c) displaying a first image on a display upon detecting of step b);
d) receiving of at least one signal from at least one of the sensing elements by the tablet computer;
e) processing of the signal of step d) according to predetermined rules;
f) generating image data for a second image based on the processed signal of step e);
g) displaying the second image of step f) on the computer display;
h) repeating steps d)-g).

27. (canceled)

28. (canceled)

29. (canceled)

30. Playing surface for placing on a playing field of the game board, the game board comprising:
a playing field, the playing field comprising a plurality of sensing elements, each capable of detecting the presence of a game piece on one or more predefined positions on the playing field, which sensing elements are capable of generating a signal upon said detection,
accommodating means for accommodating a tablet computer on the game board, and
connecting means to establish an operational link for signal transfer between the sensing elements of the playing field and the tablet computer.
wherein the playing surface comprises a sheet on which discrete areas are defined, which areas correspond with the location of one or more sensing elements of the game board, when the playing surface is placed on the playing field of the game board.

31. Playing surface according to claim 30, comprising mounting means for mounting the playing surface on the playing surface of the game board.

32. (canceled)

33. A data carrier on which a computer program product is stored, the computer program product comprising instructions that are readable and executable by a tablet computer that is suitable to be accommodated in a game board, the game board comprising:
a playing field, the playing field comprising a plurality of sensing elements, each capable of detecting the presence of a game piece on one or more predefined positions on the playing field, which sensing elements are capable of generating a signal upon said detection,
accommodating means for accommodating the tablet computer on the game board, and
connecting means to establish an operational link for signal transfer between the sensing elements of the playing field and the tablet computer;
wherein the computer program product enables the tablet computer to perform a method comprising the steps of:
a) establishing an operational link between one or more of the sensing elements of the game board and the tablet computer;
b) detecting the operational link of step a);
c) displaying a first image on a display upon detecting of step b);
d) receiving of at least one signal from at least one of the sensing elements by the tablet computer;
e) processing of the signal of step d) according to predetermined rules;
f) generating image data for a second image based on the processed signal of step e);
g) displaying the second image of step f) on the computer display;
h) repeating steps d)-g).

34. A kit comprising:
a playing surface according to claim 30; and
a computer program product comprising instructions that are readable and executable by a tablet computer that is suitable to be accommodated in the game board, enabling the said tablet computer to perform a method including the steps of:
a) establishing an operational link between one or more of the sensing elements of the game board and the tablet computer;
b) detecting the operational link of step a);
c) displaying a first image on a display upon detecting of step b);
d) receiving of at least one signal from at least one of the sensing elements by the tablet computer;
e) processing of the signal of step d) according to predetermined rules;
f) generating image data for a second image based on the processed signal of step e);
g) displaying the second image of step f) on the computer display;
h) repeating steps d)-g).
